(19) United States
(12) Patent Application Publication
(10) Pub. No.: US 2004/0017495 A1
(43) Pub. Date: Jan. 29, 2004

(54) Image sensor for suppressing image distortion

(75) Inventors: Jun Funakoshi, Kawasaki (JP); Katsuyosi Yamamoto, Kawasaki (JP)

Correspondence Address: ARENT FOX KINTNER PLOTKIN & KAHN, 1050 CONNECTICUT AVENUE, N.W., SUITE 400, WASHINGTON, DC, 20036, US

(73) Assignee: FUJITSU LIMITED

(21) Appl. No.: 10/618,709

(22) Filed: Jul. 15, 2003

(30) Foreign Application Priority Data
Jul. 25, 2002 (JP) 2002-216848
Oct. 31, 2002 (JP) 2002-317034

(51) Int. Cl. H04N 5/335

(52) U.S. Cl. 348/308

(57) ABSTRACT

An image sensor has a pixel array where pixels having photoelectric conversion elements are arranged in a matrix, a plurality of row select lines which are arranged in a row direction, a plurality of column lines which are arranged in a column direction, a sample hold circuit disposed in each column line, a vertical scan circuit for generating vertical scan signals to sequentially select the plurality of row select lines, and a horizontal scan circuit for generating horizontal scan signals to sequentially select the output of the sample hold circuit. The vertical scan circuit sequentially selects and scans the plurality of row select lines within a first vertical scan period when the image sensor is controlled to a first frame period, and also sequentially selects and scans the plurality of row select lines within the first vertical scan period even when the image sensor is controlled to a second frame period, which is longer than the first frame period.

### CROSS-REFERENCE TO RELATED APPLICATIONS

This application is based upon and claims the benefit of priority from the prior Japanese Patent Applications No. 2002-216848, filed on Jul. 25, 2002 and No. 2002-317034, filed on Oct. 31, 2002, the entire contents of which are incorporated herein by reference.

### BACKGROUND OF THE INVENTION

1. Field of the Invention

The present invention relates to an image sensor using a photoelectric conversion element, and more particularly to an image sensor which suppresses distortion of output images.

2. Description of the Related Art

An image sensor, such as a CMOS sensor, has photo-conversion elements as pixels, converts intensity of light which enters during a predetermined integration period into electric signals, performs image processing, and outputs image signals. When the row select line is driven, the photoelectric conversion signals of the pixels connected to the row select line are held by the sample hold circuit which is disposed for each column, and these detected signals which are held are sequentially output by horizontal scan pulses. Also the row select lines are sequentially driven by vertical scan pulses, and the output of the pixel signals for one frame of the image completes when all the row select lines are scanned.

Such a CMOS image sensor is disclosed in Japanese Patent Laid-Open No. 2002-218324, for example.

Since the photoelectric conversion signals, which are generated by photoelectric conversion and are integrated at each pixel, are sequentially output by scanning a plurality of row select lines, the integration period shifts between the top and bottom of the image, even in a same frame image. For example, when one frame period is 1/30 seconds, all the row select lines are scanned in 1/30 seconds, and a maximum 1/30 second shift of the integration period is generated between the top and bottom parts of the image. Also in the case of dark images, the output image must be brightened by making the integration period longer, so in this case, it is controlled such that one frame period becomes longer to 1/15 seconds or 1/7.5 seconds, and the integration period at the top and bottom parts of the image shift 1/15 seconds or 1/7.5 seconds accordingly.

The shift of the integration period, depending on the vertical position of a same frame of the image, causes distortion of the output image when the image moves in the left and right direction at high-speed, for example, because of the shift of position between the top and bottom parts of the output image.

### SUMMARY OF THE INVENTION

With the foregoing in view, it is an object of the present invention to provide an image sensor which suppresses distortion of the output image.

To achieve the above object, one aspect of the present invention is an image sensor which has a pixel array where pixels having photoelectric conversion elements are arranged in a matrix, comprising, a plurality of row select lines which are arranged in a row direction, a plurality of column lines which are arranged in a column direction, a sample hold circuit disposed in each column line, a vertical scan circuit for generating vertical scan signals to sequentially select the plurality of row select lines, and a horizontal scan circuit for generating horizontal scan signals to sequentially select the output of the sample hold circuit, wherein the vertical scan circuit sequentially selects and scans the plurality of row select lines within a first vertical scan period when the image sensor is controlled to a first frame period, and also sequentially selects and scans the plurality of row select lines within the first vertical scan period even when the image sensor is controlled to a second frame period, which is longer than the first frame period.

According to the above mentioned aspect of the invention, even if the frame period is controlled to the second frame period, which is longer than the first frame period, when the image to be captured is dark, for example, so that the integration period in the pixels is increased, the speed of the vertical scan is the same speed as in the first frame period, so the shift of the integration period between the top and bottom parts of the image does not increase and the distortion of output images can be suppressed.

### BRIEF DESCRIPTION OF THE DRAWINGS

FIG. 1 is a diagram depicting the configuration of the pixel array of the CMOS image sensor according to the present embodiment;

FIG. 2 is a diagram depicting an embodiment of the sample hold circuit;

FIG. 3 is a signal waveform diagram depicting operation of the sample hold circuit;

FIG. 4 is a diagram depicting the configuration of the color processor of the image sensor according to the present embodiment;

FIG. 5 is a diagram depicting the relationship between vertical scan and horizontal scan according to the present embodiment;

FIG. 6 is a diagram depicting the control circuit of vertical scan and horizontal scan according to the present embodiment;

FIG. 7 is a diagram depicting a modification of FIG. 4; and

FIG. 8 is a diagram depicting the input timing and the output timing to the line buffer 60.

### DESCRIPTION OF THE PREFERRED EMBODIMENTS

Embodiments of the present invention will now be described with reference to the accompanying drawings. The protective scope of the present invention, however, is not limited to the embodiments herein below, but encompasses the invention stated in the claims and equivalents thereof.

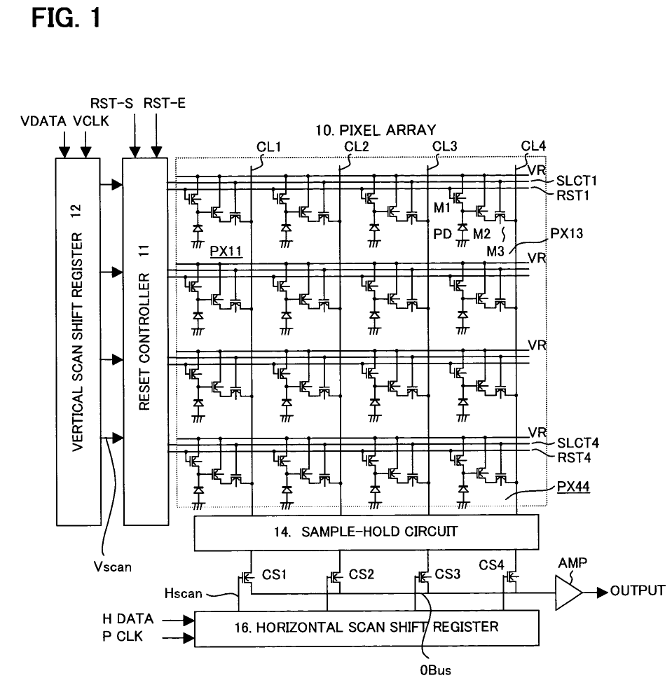

FIG. 1 is a diagram depicting the configuration of the pixel array of the CMOS image sensor according to the present embodiment. The pixel array 10 is comprised of a plurality of reset power supply lines VR, row select lines SLCT0-3, and reset control lines RST0-3, each of them arranged in a row direction, a plurality of column lines CL1-4 arranged in a column direction, and pixels PX00-33 arranged at intersecting positions between the row select lines, the reset control lines and column lines. In each pixel, disposed are photoelectric conversion circuits, each of which is comprised of a transistor for reset M1, a photodiode PD, that is a photoelectric conversion element, a source follower transistor M2 for amplifying cathode potential of the photodiode, and a selecting transistor M3, for connecting the source of the source follower transistor M2 and the column line CL responding to the drive of the row select line SLCT, as shown in the pixel PX03.

Driving of the row select lines SLCT0-3 arranged in a row direction and the reset control lines RST0-3 is controlled by the vertical scan shift register 12 and the reset control circuit 11. In other words, the vertical scan shift register 12 is a vertical scan circuit for generating the vertical scan signals Vscan, and generates the vertical scan signals Vscan for selecting each row by transferring “1” of the data VDATA in serial, responding to the vertical scan clock VCLK. The row select lines SLCT0-3 are sequentially driven responding to the vertical scan signals.

Each column line CL1-4, which are arranged in a column direction, are connected to the sample hold circuit 14 respectively. As mentioned later, the sample hold circuit 14 amplifies the photoelectric conversion signals which are supplied from each pixel via the column lines CL, deletes a reset noise generated along with a reset operation, and outputs the pixel signals.

The pixel signals which are output from the sample hold circuit 14 are output to the common output bus OBUS via the column select transistors SC0-3 which are selected by the horizontal scan signals Hscan generated by the horizontal scan shift register 16, and are amplified by the amplifier AMP connected to the output bus. The output of the amplifier AMP is supplied to the later mentioned color processor.

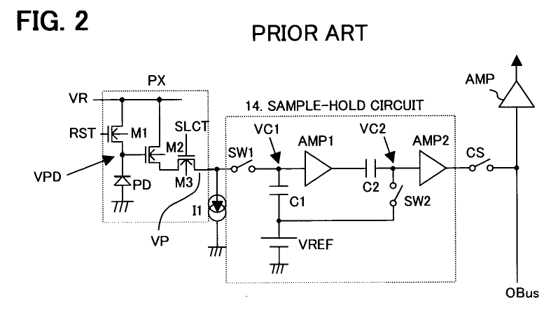

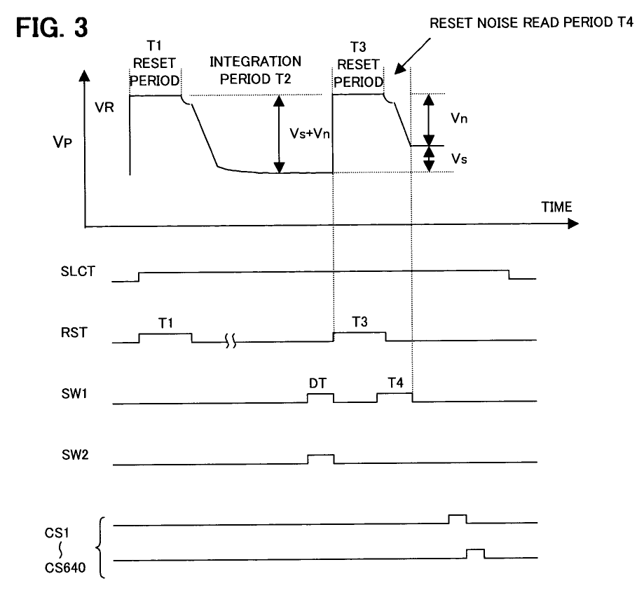

FIG. 2 is a diagram depicting an embodiment of the sample hold circuit, and FIG. 3 is a signal waveform diagram depicting operation of the sample hold circuit. FIG. 2 shows the circuit of one pixel PX, and the sample hold circuit 14 which is connected to the pixel PX via a column line, which is not illustrated. The sample hold circuit 14 is comprised of a first switch SW1, a second switch SW2, a first sample hold capacitor C1, a second sample hold capacitor C2, a reference voltage VREF, and first and second amplifiers AMP1 and AMP2, and is a correlative double sampling circuit for canceling the reset noise of the photoelectric conversion circuit of the pixel. The current supply I1 is disposed between the pixel PX and the sample hold circuit 14.

The pixel PX and operation of the sample hold circuit 14 will be described with reference to FIG. 3. FIG. 3 shows the voltage change of the cathode voltage VPD of the photodiode D1 in the pixel in association with the row select line SLCT and reset control line RST. At first, in the reset period T1, the reset control line RST is driven to H level, the reset transistor M1 turns ON, and the cathode potential VPD of the photodiode PD is set to the reset level VR. When the reset control line RST becomes L level and the reset transistor M1 is turned OFF, the cathode potential VPD gradually decreases its level by the current which the photodiode PD generates according to the intensity of the input light. This is the integration period T2. However, the reset noise Vn is generated when the reset transistor M1 turns OFF. This reset noise Vn is voltage which is dispersed depending on the pixel.

After the predetermined integration period T2 has elapsed, the row select line SLCT is driven to H level, so that the selecting transistor M3 of the pixel turns ON, and in this status, the switches SW1 and SW2 are temporarily turned ON, and the drive current from the source follower transistor M2, which is generated according to the cathode potential VPD, recharges the capacitor C1 via the selecting transistor M3 and the column line, which is not illustrated. By this, the node VC1 becomes potential VR−(Vs+Vn), which is the difference between the sum of the reset noise voltage Vn and the potential Vs which dropped during the integration period, that is (Vs+Vn), and the reset voltage VR. The potential of the node VC1 is also transferred to the second capacitor C2 via the first amplifier AMP1.

At this time, the second switch SW2 is also in ON status, and if the amplification factor of the first amplifier AMP1 is 1, the second capacitor C2 is also charged to the same voltage status as the first capacitor. In this status, the differential voltage between the level VR−(Vs+Vn) and the reference voltage VREF is applied to the first and second capacitors C1 and C2.

After the integration period T2 ends, the reset pulse is supplied again to the reset control line RST, and the reset transistor M1 turns ON. By this, the cathode potential VPD is charged again to the reset level VR. Then after the reset noise read period T4 has elapsed, the first switch SWl is temporarily turned ON. At this time, the second switch SW2 is maintained in OFF status. In this reset noise read period T4 as well, the level of the cathode potential VPD decreases by the current of the photodiode according to the received light intensity, just like the integration period T2, but the reset noise read period T4 is set shorter compared with the integration period T2. However, the integration period T2 is controlled to be an optimum period according to the brightness level of the input light, so the periods T2 and T4 cannot always simply be compared.

During this reset noise read period T4, the switch SWl turns ON, and the node VC1 of the first capacitor C1 becomes the level VR−Vn, which is the level dropped from the reset voltage VR by the reset noise Vn. This potential VR−Vn is transferred to the terminal of the second capacitor C2 via the first amplifier AMP1. At this time, the second switch SW2 is in OFF status, so the node VC2 of the second capacitor C2 is in open status. Therefore a fluctuation of the differential voltage Vs, between the potential VR−(Vs+Vn) of the node VC1 at the end of the integration period T2 and the potential VR−Vn of the node VC1 at the end of the reset noise read period T4, occurs in the node VC2 of the second capacitor C2, and the voltage VREF+Vs, which is the sum of the reference voltage VREF at the first sampling and the differential voltage Vs, is generated in the node VC2. The reset noise Vn has been removed from this voltage VREF+Vs.

By setting the reference potential of the second amplifier AMP2 to VREF, the detected voltage Vs, which has been integrated according to the received light intensity, is amplified by the second amplifier AMP2, and is output to the output bus OBUS via the column gate CS, which is sequentially controlled ON by the horizontal scan signals generated by the horizontal scan shift register 16. And this output is amplified by the common amplifier AMP which is disposed in the output bus OBUS, and is supplied to the A/D conversion circuit in a subsequent stage as pixel signals.

The vertical scan circuit 12, which is comprised of a shift register, generates vertical scan signals Vscan by shifting “1” of the vertical data VDATA, which is supplied at the beginning of the scan period, synchronizing with the vertical clock VCLK. Therefore the scan drive of the row select lines SLCT0-3 is controlled by the timing of generating the vertical scan signals. In the same way, the horizontal scan circuit 16, which is comprised of a shift register as well, generates the horizontal scan signal Hscan by shifting “1” of the horizontal data HDATA, which is supplied at the beginning of the scan period, synchronizing with the pixel clock PCLK. The column gates CS1-4 are sequentially selected by these horizontal scan signals. Therefore by the timing to generate this horizontal scan signal, the scan drive in the horizontal direction is controlled.

The period where the row select signal SLCT is controlled to be H level in FIG. 3 is the scan period of the row. Therefore while the row select signal SLCT of a row is controlled to be H level, the photoelectric conversion signals from the pixels of the row are output as pixel signals via the sample hold circuit 14, column gate CS, common bus OBus, and amplifier AMP. When this output ends, the row select signal SLCT of the next row is controlled to be H level, and a similar pixel signal output operation is executed. In other words, the row scan operation in FIG. 3 is sequentially executed for the number of rows of the pixel array.

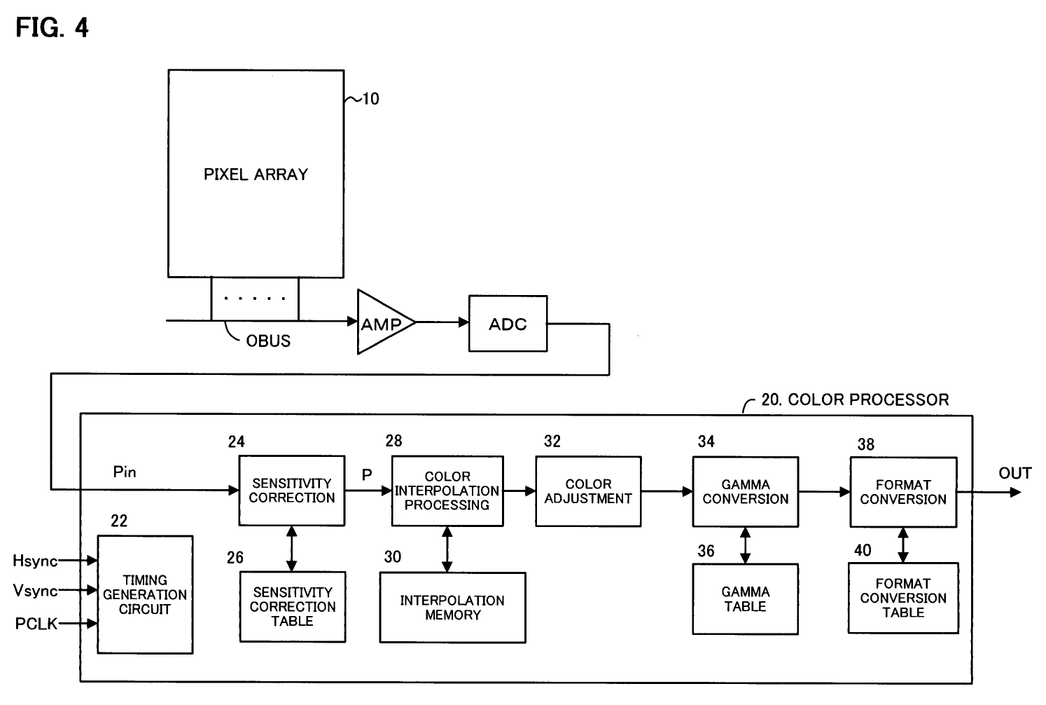

FIG. 4 is a diagram depicting the configuration of the color processor (image processor) of the image sensor according to the present embodiment. The photoelectric conversion signals detected in the pixel array 10 are supplied to the color processor 20 as pixel signals Pin via the output bus OBUS, amplifier AMP, and A/D conversion circuit ADC. When the RGB color filter is disposed on the pixel array 10, the pixel signals Pin become signals with each color of RGB.

The color processor 20 comprises a timing generation circuit 22 which generates various timing signals from the horizontal synchronization signal Hsync used for driving of the pixel array 10, vertical synchronization signals Vsync and pixel clock PCLK. Also the color processor 20 further comprises a sensitivity correction circuit 24 for correcting characteristics which depend on the sensitivity of the color of the pixel signals Pin, a color interpolation processing circuit 28 which determines the gradation value of a color, other than the colors detected for each pixel, by the interpolation operation from the pixel signals of the surrounding pixels, a color adjustment circuit 32 for adjusting tone (e.g. blueness of blue), and a gamma conversion circuit 34 for matching the output data to the device characteristics (gamma characteristics) of the device which outputs images, such as an LCD and CRT. And finally a format conversion circuit 38 for converting the format of image signals into a format appropriate for the display device, converts pixel signals into the format of the digital component, such as NTSC, YUV and YCbCr, then the image data is output.

To correct characteristics which depend on the sensitivity of a color, the sensitivity correction circuit 24 refers to the sensitivity correction table 26 which is created corresponding to each color, and performs the correction operation. The color interpolation processing circuit 28 generates the pixel signals of RGB for each pixel. When the configuration of the color filter disposed in the pixel array 10 is a Bayer array, for example, pixel signals for green (G) and blue (B) cannot be received for the pixels corresponding to red (R). Therefore the color interpolation processing circuit 28 interpolates the signals of the surrounding pixels, so that the pixel signals for green (G) and blue (B) can be generated for the pixels of the color filter of red (R). For this, the pixel signals of the surrounding pixels are temporarily recorded in the interpolation memory 30. And the color interpolation processing circuit 28 performs the interpolation operation for the pixel signals of the surrounding pixels which are temporarily recorded in the interpolation memory 30. In the gamma table 36, the conversion table for converting the output data into the gamma characteristics of the image output device, such as a CRT and LCD, is stored. The format conversion table 40 is a table for converting the output data into the display signal format, such as NTSC and YUV.

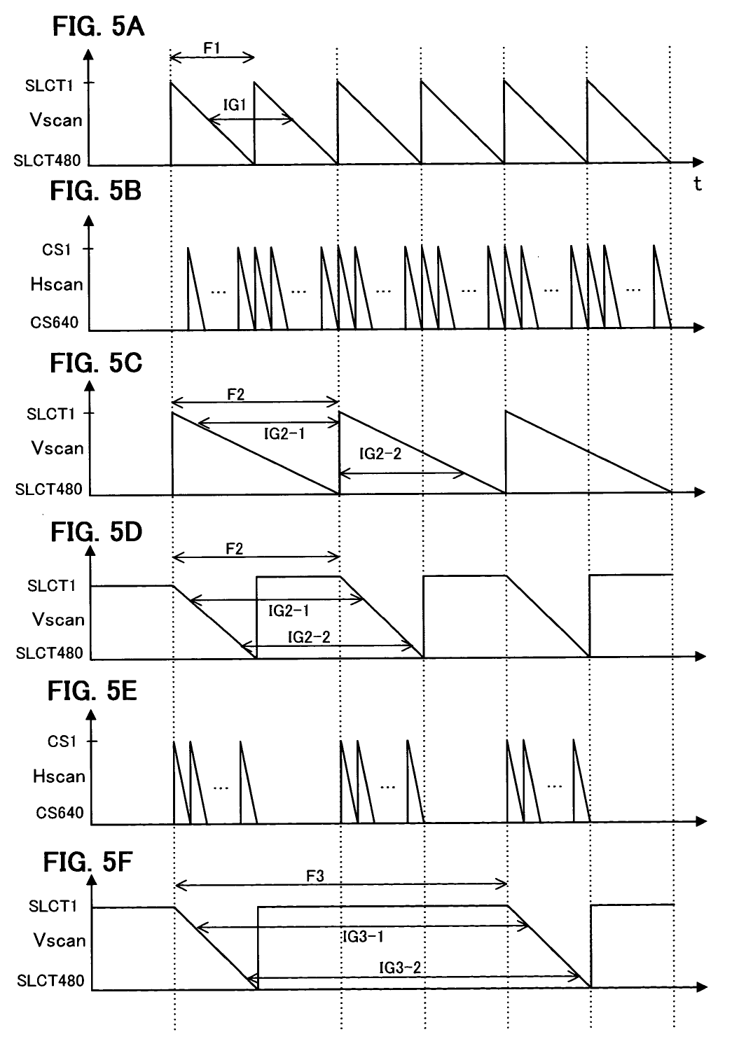

FIG. 5 is a diagram depicting the relationship between vertical scan and horizontal scan according to the present embodiment. In FIG. 5A, 5C, 5D and 5F show the drive operation for the row select line to be vertically scanned, and the abscissa indicates the time and the ordinate indicates the scan position of the row select lines SLCT1-480. In FIG. 5, 5B and 5H show the scan positions of the column gates CS1-640 to be horizontally scanned. This is an example when the pixel array 10 has 480 rows and 640 columns.

FIG. 5A and 5B show vertical scan and horizontal scan in the first frame period F1. In the vertical scan FIG. 5A, the vertical scan shift register 12 transfers the vertical data VDATA=1 from the first row to 480th row synchronizing with the vertical clock VCLK to sequentially generate the vertical scan signals, and along with this, the row select lines SLCT 1-480 are sequentially driven within the frame period F1. Also while each row select line is driven, the horizontal scan shift register 16 transfers the horizontal data HDATA=1 from the first column to the 640th column synchronizing with the pixel clock PCLK to sequentially generate the horizontal scan signals, and along with this, the column gates CS1-640 are sequentially selected within 1/480 seconds of the frame period F1. Therefore in this case, the integration period IG1 becomes the same as the first frame period F1 at the maximum. The deviation of the integration periods for the first line and the 480th line becomes the first frame period F1.

FIG. 5C shows a conventional vertical scanning when the image sensor is controlled to the second frame period F2, which is double the length of the first frame period F1. When the input image is dark, gain of the amplifier AMP disposed in the output bus OBUS is controlled to be increased so as to increase the level of the pixel signals to be output, but if the level is insufficient, even if the gain is set to the maximum, the integration period must be controlled to be longer. In this case, the dividing ratio of the clock is normally increased so that the speed of the scan clock of the vertical scan shift register 12 and horizontal scan shift register 16 is decreased. In the example of (C) in FIG. 5, the dividing ratio is increased to double, so that the cycle of the scan clock VCLK and PCLK becomes double.

In this case, for the vertical scan, the vertical scan shift register 12 transfers the vertical data VDATA=1 from the first row to the 480th row synchronizing with the vertical clock VCLK to sequentially generate the vertical scan signals within the second frame period F2, and along with this, the row select lines SLCT 1-480 are sequentially driven within the second frame period F2. Therefore the integration period IG2 becomes the second frame period F2 at the maximum, and a sufficient pixel signal level can be secured even for dark input images.

However, decreasing the vertical scan speed to ½ causes a time shift for the amount of the second frame period F2 between the integration period IG2-1 of the first row and the integration period IG2-2 of the 480th row. Because of such a long time shift, the image capturing target position greatly changes between the top part and bottom part of the image when the input image is moving in the left and right direction. This causes a distortion of the output image.

FIG. 5D and 5E show the vertical scan and horizontal scan according to the present embodiment. In the present embodiment, the vertical scan period is controlled to remain in the first frame period F1, even though the frame period is controlled to be the second frame period F2. In other words, the vertical scan shift register 12 is controlled so that the vertical scan completes in the first half period of the second frame period F2. In the latter half period of the second frame period, operation of the vertical scan shift register 12 stops, and none of the row select lines are driven. And the horizontal scan operation of the horizontal scan shift register 16 is repeated while vertical scan is executed. In other words, horizontal scan from the first column gate CG1 to the 640th column gate CG640 is executed in each row scan period during the vertical scan.

In this way, by maintaining the period when the vertical scan is executed in the first frame period F1, not the second frame period F2, the time shift between the integration period IG2-1 of the first row and the integration period IG2-2 of the 480th row is controlled to within the first frame period F1, which is the same as the case of FIG. 5A. Therefore the distortion of the output image is suppressed.

FIG. 5F shows the vertical scanning in the present embodiment. In this example, the frame period is controlled to be even longer, that is, controlled to be the third frame period F3, which is double the length of the second frame period F2. In this case, vertical scan is executed in the first ¼ period of the frame period F3. And the shift operation of the vertical scan shift register stops in the remaining ¾ period. Although not shown in the diagram, the horizontal scanning is sequentially executed while each row is selected during vertical scan, just like FIG. 5E.

In this case, the integration period IG3 can be extended up to the third frame period F3 at the maximum, but the time shift between the integration period IG3-1 of the first row and the integration period IG3-2 of the 480th row can be suppressed to be the same as the case of the first frame period F1. Therefore the distortion of the output image can be suppressed.

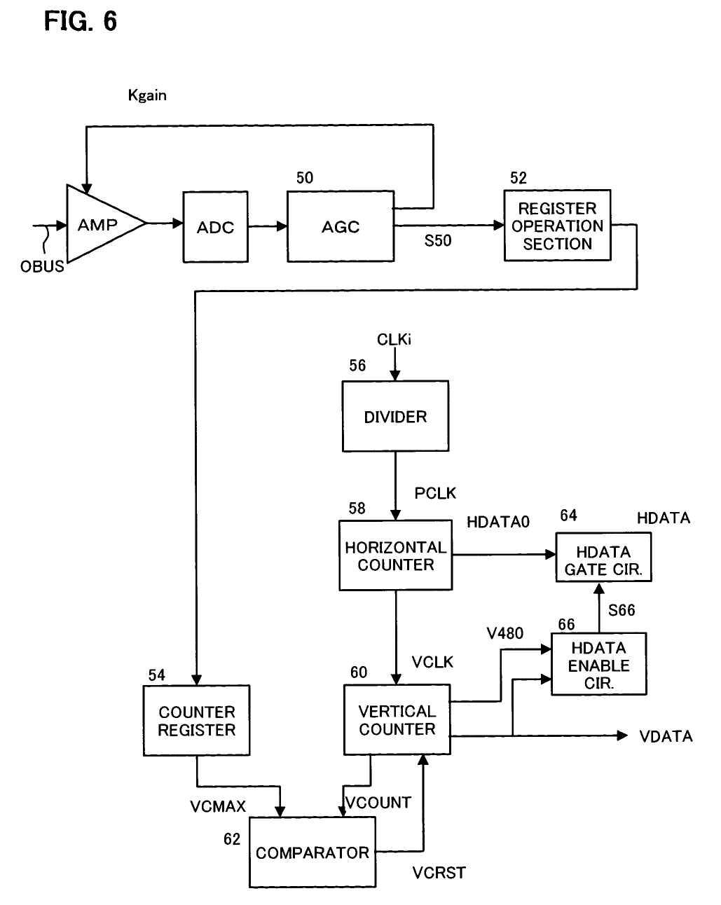

FIG. 6 is a diagram depicting the control circuit of the vertical scan and horizontal scan according to the present embodiment. The internal clock CLKi generates the pixel clock PCLK using the divider 56 at a predetermined dividing ratio. This pixel clock PCLK is used as the synchronization clock of the horizontal scan shift register 16, and is also supplied to the horizontal counter 58. The horizontal counter 58 is a counter for counting 1-640, and outputs the horizontal data HDATA0=1 when the count value is “1”. The horizontal counter 58 also outputs the vertical clock VCLK each time 640 is counted. This vertical clock VCLK is used as the control clock of the vertical scan shift register 12, and is also supplied to the vertical counter 60, and the vertical counter 60 counts the vertical clock VCLK and outputs the vertical data VDATA=1 when the count value is “1”. The maximum count value of the vertical counter 60 is designed to be a value which can support the controllable maximum frame period, but in a normal count operation, the vertical counter 60 counts until being reset, responding to the vertical count reset signal VCRST.

The gain Kgain of the amplifier AMP connected to the output bus OBUS is controlled by the automatic gain control circuit 50. The automatic gain control circuit 50 accumulates the digital value of the pixel signal level within a one frame period, which is output from the amplifier AMP, and controls the gain Kgain of the amplifier AMP according to the cumulative value of the pixel signal level. In other words, the automatic gain control circuit 50 controls the gain Kgain to be increased when the image is dark and the image signal level is generally low, so that the output image becomes brighter. However, if a sufficient pixel signal level cannot be obtained even if the gain Kgain is controlled to be the maximum value, the AGC circuit 50 supplies the frame period setting signal S50 to the register operation section 52, and controls so as to double the frame period. Responding to the frame period setting signal S50, the resister operation section 52 sets the register value of the counter register 54 to be double. In other words, the maximum vertical scan count value VCMAX to be set in the counter register 54 becomes double. For example, this maximum count value VCMAX is set to 480×2=960.

The comparison circuit 62 compares the maximum vertical scan count value VCMAX and the count value VCOUNT of the vertical counter 60, and outputs the vertical count reset signal VCRST when these values match. Responding to this, the vertical counter 60 is reset, the vertical count value becomes “1”, and the vertical data VDATA=1 is output.

When the vertical count value VCOUNT becomes 1, the vertical counter 60 outputs the vertical data signal VDATA=1, and when the vertical count value VCOUNT becomes 480, the vertical counter 60 outputs the count signal V480=1. And responding to the vertical data VDATA=1, the horizontal data enable circuit 66 enables the enable signal S66, and responding to the count signal V480=1, the horizontal data enable circuit 66 disables the horizontal scan enable signal S66.

The horizontal counter 58 outputs the horizontal data signal HDATA0=1 each time the count value becomes “1”, but outputs the horizontal data signal HDATA=1 only while the horizontal data enable signal S66 is in enable status by the gate circuit 64.

Now operation of the control circuit in FIG. 6 in the case of FIG. 5A and 5B will be described. In this case, the control circuit is controlled to the first frame period F1, which is the shortest, so the counter register 54 is set to 480. And the horizontal counter 58 outputs the horizontal data HDATA=1 at the counter value “1”, and at the same time, the vertical counter 60 outputs the vertical data VDATA=1 at the counter value “1”. By this, the horizontal scan register 16 sequentially shifts the horizontal scan signals synchronizing with the pixel clock PCLK. And each time the horizontal counter 58 counts 640, the vertical clock VCLK is output, which is counted by the vertical counter 60. When the vertical count value VCOUNT reaches the set value 480 of the counter register 54, the vertical counter is reset. In other words, in the case of FIG. 5 (A) and (B), vertical scan is sequentially executed synchronizing with the vertical clock VCLK during the first frame period F1, and during each vertical scan, horizontal scan is sequentially executed synchronizing with the pixel clock PCLK.

Now operation of the control circuit in the case of FIG. 5D and 5E will be described. In this case, the image sensor is controlled to the second frame period F2, which is double the length of the first frame period F1, so the counter register 54 is set to 480×2=960. And while the vertical counter 60 is at count value 1-480, the horizontal data HDATA0, which the horizontal counter 58 outputs, passes through the gate circuit 64 and is supplied to the horizontal scan shift register 16 as the horizontal data HDATA. By this, while the vertical counter 60 is at the count value 1-480, the horizontal scan shift register 16 outputs the horizontal scan signal during each vertical scan. However, if the count value of the vertical counter 60 exceeds the count value 480, the enable signal S66 is disabled, so the gate circuit 64 disables the output of the horizontal data HDATA=1. As a result, while the count value of the vertical counter is 481-960, the horizontal data signal HDATA=1 is not output, and the horizontal scan shift register 16 does not output the horizontal scan signal.

After the vertical data signal VDATA=1 is output when the count value of the vertical counter 60 is “1”, the data signal VDATA=1 is not output until the vertical count value becomes 960, so the vertical scan shift register 12 generates the vertical scan signal only in the first half of the second frame period F2, and does not output any vertical scan signal in the latter half.

In the case of FIG. 5F, the counter register 54 is set to 480×4=1960, so the vertical scan signals and horizontal scan signals are generated only in the first ¼ period of the third frame period F3, and neither the vertical scan signals nor the horizontal scan signals are generated during the rest of the period.

### Modified Examples of Horizontal Scan

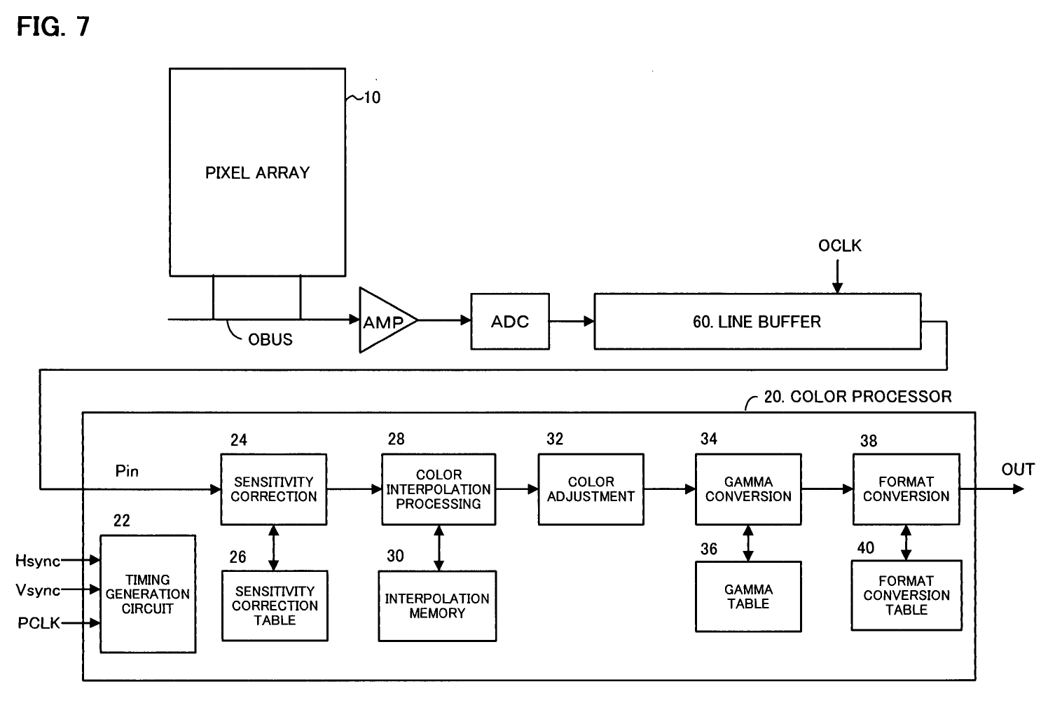

Now modified examples of the horizontal scanning operation, in the case of control by FIG. 5A and in the case of control by FIG. 5C, will be described. FIG. 7 is a diagram depicting a modified example of FIG. 4. In the example of FIG. 7, a line buffer 60, which can store a row of pixel signals Pin, is disposed between the A/D conversion circuit ADC, disposed in the output stage of the pixel array, and the color processor 20. And to this line buffer 60, pixel signals for one row, 640 pixels, are input responding to the column gates CS1-640 turning ON. And the one row of pixel signals stored in the line buffer 60 are output to the color processor 20 synchronizing with the output clock OCLK.

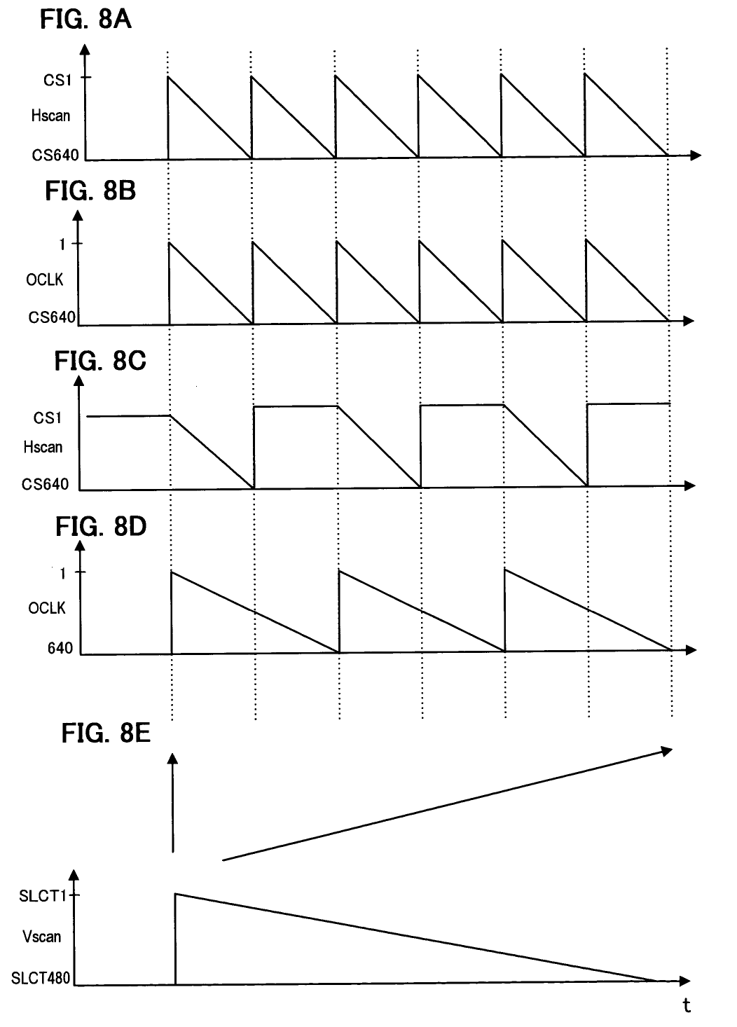

FIG. 8 is a diagram depicting the input timing and output timing to the line buffer 60. FIG. 8 (E) shows the timing of vertical scan, and the timing of input/output to the line buffer 60 during vertical scan are shown in FIG. 8A-8D.

FIG. 8A and 8B are the input timing and output timing when the image sensor is controlled to the first frame period F1, as shown in FIG. 5A. In this case, the pixel signals are input to the line buffer 60 at the same timing as the horizontal scan signals which are generated synchronizing with the pixel clock PCLK, and are output at the same timing. In other words, the cycle of the output clock OCLK is the same as the cycle of the pixel clock PCLK.

FIG. 8C and 8D are the input timing and output timing when the image sensor is controlled to the second frame period F2, as shown in FIG. 5C. In this case, the speed of the vertical scanning clock VCLK is decreased, as shown in prior art, and the scan period of each row is double. In this case as well, as shown in FIG. 8C, horizontal scan signals are generated in the first half of the scan period of each row, and 640 pixel signals for one row are input to the line buffer 60. However, the output clock OCLK is controlled to the ½ speed of the pixel clock PCLK, and outputs 640 pixel signals at a double length cycle. By this, the pixel clock PCLK for controlling the shift operation of the horizontal scanning shift register is maintained at the same speed. Output of the pixel signals to the color processor 20, however, is dropped to ½ speed.

According to the present invention, the shift of integration time of the image sensor decreases and the distortion of an output image is suppressed, and therefore image quality is improved.

What is claimed is:

1. An image sensor for capturing images, comprising:
a pixel array where pixels having photoelectric conversion elements are arranged in a matrix;
a plurality of row select lines which are arranged in a row direction in said pixel array;
a plurality of column lines which are arranged in a column direction in said pixel array;
a sample hold circuit disposed in each one of said column lines;
a vertical scan circuit for generating vertical scan signals to sequentially select said plurality of row select lines; and
a horizontal scan circuit for generating horizontal scan signals to sequentially select an output of said sample hold circuit,
wherein said vertical scan circuit sequentially selects and scans said plurality of row select lines within a first vertical scan period when said image sensor is controlled to a first frame period, and also sequentially selects and scans said plurality of row select lines within said first vertical scan period even when said image sensor is controlled to a second frame period, which is longer than said first frame period.

2. The image sensor according to claim 1, wherein said horizontal scan circuit generates said horizontal scan signals while said vertical scan circuit selects each one of said row select lines, and said horizontal scan circuit does not generate said horizontal scan signals when said vertical scan circuit does not generate said vertical scan signals.

3. The image sensor according to claim 1, wherein said pixel comprises a photoelectric conversion element, a reset transistor, a source follower transistor, and a selecting transistor which is controlled by said row select lines.

4. The image sensor according to claim 1, wherein said first vertical scan period is a period which is a part of said first frame period.

5. An image sensor for capturing images, comprising:
a pixel array where pixels having photoelectric conversion elements are arranged in a matrix;
a plurality of row select lines which are arranged in a row direction in said pixel array;
a plurality of column lines which are arranged in a column direction in said pixel array;
a sample hold circuit disposed in each one of said column lines for sample holding photoelectric conversion signals of said pixels;
a vertical scan circuit for generating vertical scan signals to sequentially select said plurality of row select lines; and
a horizontal scan circuit for generating horizontal scan signals to sequentially select an output of said sample hold circuit while each one of said row select lines is selected,
wherein said vertical scan circuit sequentially selects and scans said plurality of row select lines within a first vertical scan period when said image sensor is controlled to a first frame period, and also sequentially selects and scans said plurality of row select lines within said first vertical scan period even when said image sensor is controlled to a second frame period, which is longer than said first frame period.

6. The image sensor according to claim 5, wherein said vertical scan circuit does not output said vertical scan signals after said first vertical scan period in said frame period has elapsed.

7. An image sensor for capturing images, comprising:
a pixel array where pixels having photoelectric conversion elements are arranged in a matrix;
a plurality of row select lines which are arranged in a row direction in said pixel array;
a plurality of column lines which are arranged in a column direction in said pixel array;
a sample hold circuit disposed in each one of said column lines for sample holding photoelectric conversion signals of said pixels;
a vertical scan circuit for generating vertical scan signals to sequentially select said plurality of row select lines; and
a horizontal scan circuit for generating horizontal scan signals to sequentially select the output of said sample hold circuit while each one of said row select lines is selected,
wherein said vertical scan circuit sequentially selects and scans said plurality of row select lines within the vertical scan period which is a part of the frame period, and does not select said row select lines outside said vertical scan period in said frame period.

8. The image sensor according to one of claims 1, 5 and 7, further comprising:
a line buffer for storing one row of output of said sample hold circuit; and
an image processor for inputting an output of said line buffer,
wherein in the horizontal scan period, an output signal of said sample hold circuit is stored in said line buffer responding to said horizontal scan signal, and said output signal in said line buffer is output to said image processor responding to an output clock with a cycle longer than said horizontal scan signal.

9. An image sensor for capturing images, comprising:
a pixel array where pixels having photoelectric conversion elements are arranged in a matrix;
a plurality of row select lines which are arranged in a row direction in said pixel array;
a plurality of column lines which are arranged in a column direction in said pixel array;
a sample hold circuit disposed in each one of said column lines for sample holding photoelectric conversion signals of said pixels;
a vertical scan circuit for generating vertical scan signals to sequentially select said plurality of row select lines;
a horizontal scan circuit for generating horizontal scan signals to sequentially select the output of said sample hold circuit when each one of said row select lines is selected;
a line buffer for storing one row of output of said sample hold circuit; and
an image processor for inputting an output of said line buffer,
wherein in the horizontal scan period, output signal of said sample hold circuit is stored in said line buffer responding to said horizontal scan signal, and said output signal in said line buffer is output to the said image processor responding to an output clock with a cycle longer than said horizontal scan signal.
